(19) United States
(12) Patent Application Publication
(10) Pub. No.: US 2008/0297347 A1
(43) Pub. Date: Dec. 4, 2008

(54) Automatic Configuration of New or Replacement Eas Network Devices

(75) Inventors: John Jay Clark, Boynton Beach, FL (US); David Fallin, Coral Springs, FL (US); Scott Alan Tribbey, Coconut Creek, FL (US); Jose Ramos, Coral Springs, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation, Boca Raton, FL (US)

(21) Appl. No.: 11/667,990

(22) PCT Filed: Nov. 16, 2005
(86) PCT No.: PCT/US2005/041366

§ 371 Date: Feb. 25, 2008

Related U.S. Application Data
(60) Provisional application No. 60/628,313, filed on Nov. 16, 2004.

(51) Int. Cl. G08B 13/22

(52) U.S. Cl. 340/572.1

(57) ABSTRACT

A system and an analogous method which automatically configures electronic article surveillance (EAS) devices coupled to a network, includes a server coupled to the network. The server may include software or hardware which (1) listens on a specified port for connection requests from at least one coupled EAS network device; (2) accepts the connection request from at least one coupled EAS network device; (3) queries at least one coupled EAS network device for information relating to at least one EAS network device; and (4) configures at least one coupled EAS network device based upon the information received from at least one EAS network device.

### CROSS-REFERENCE TO RELATED APPLICATIONS

This application claims the benefit of priority under 35 U.S.C. §119 to U.S. Provisional Patent Application 60/628,313 filed on Nov. 16, 2004 entitled “Automatic Configuration of New or Replacement EAS Network Devices”, the entire contents of which is incorporated herein by reference.

### BACKGROUND OF THE INVENTION

1. Field of the Invention

The invention relates to a method and a system for automatic configuration of new, replacement and unconfigured connected electronic article surveillance (EAS) related network devices.

2. Description of the Related Art

Typically, the local settings configuration for EAS devices is performed manually on-site, usually by trained service personnel. Although some EAS devices are contractor installable, the configuring of the operating parameters is typically performed by a trained service technician. For a major equipment roll out, sending a service technician to each site can be very expensive. In addition, if an EAS device needs to be replaced after initial installation, this follow-up installation is typically performed by a trained service technician. Also, if EAS network devices are subsequently added to the network, they would need to be manually configured on the server software.

Since the configuration settings of the EAS network devices are stored either at the time of installation or after installation of the EAS network devices by a service person, a configurator program is typically developed specifically for the device. Software or firmware upgrades are usually done locally of on-site requiring a service person at each location to do the upgrade. Thus, it would be desirable to provide a system or method for automatically configuring EAS devices connected to a network.

### SUMMARY OF THE INVENTION

It is an object of the present invention to provide a method and system for the automatic configuration of EAS devices connected to a network.

It is another object of the present invention provide a reduction in labor expenses for installation and maintenance of an EAS network device.

It is yet another object of the present invention to enable an EAS network device to be installed by an untrained contractor.

The present invention is directed to a system for the automatic configuration of EAS devices connected to the network. The configuration process includes both the configuration stored on the EAS network device as well as device configuration stored on the server software designed to manage and administer the EAS network devices. The server software resides on a central server connected typically to a wide area network (WAN). The server software includes device manager software. Once an EAS network device is installed on the WAN, it goes through a discovery process that allows the server software to detect the device. When an unconfigured EAS network device is discovered by the server software, a determined protocol is, used to ascertain specific information about the device, e.g., the type of device, media access control (MAC) address, current configuration information and the firmware or software revisions. The device is then automatically configured or registered in the server software as a device that needs to be managed.

Based on the device type, the appropriate settings, configuration and software revisions are sent to the EAS network device. Once the EAS network device is properly configured, the server software monitors the device for events, alarms and data. If the EAS network device needs to be replaced, a replacement unit is automatically configured with the settings from the device being replaced.

The present invention is directed also to a method of automatically configuring EAS devices coupled to a network server, and comprises the steps of: listening on a specified port for connection requests from at least one of the coupled EAS network devices; accepting the connection request from at least one of the coupled EAS network devices; querying the connected EAS network device for information relating to at least one coupled EAS network device; and configuring at least one coupled EAS network device based upon the information received from the at least one coupled EAS network device. In one particularly useful embodiment, the information relating to at least one coupled EAS network device is selected from the group consisting of (a) pre-configured global device settings, (b) the at least one coupled EAS network device type, (c) media access control (MAC) address, (d) firmware revision level, and (e) software revision level.

When the information relating to the at least one coupled EAS network device is the MAC address, the method further comprises the step of using the MAC address to uniquely define each EAS network device in software of the server. Alternatively, when the information relating to the at least one coupled EAS network device is the at least one coupled EAS network device type, the step of configuring the EAS network device includes sending configuration settings and software revisions to the at least one coupled EAS network device appropriate for the type of EAS network device.

After the step of querying the at least one coupled EAS network device for information relating to the at least one coupled EAS network device, the method may further comprise the steps of: analyzing the information received from the at least one coupled EAS network device and determining if the at least one EAS network device is defined in the server. In addition, if the at least one EAS network device is not defined in the server, the method includes adding the at least one EAS network device to a list of devices for the server to manage.

After the step of querying the at least one coupled EAS network device for information relating to the at least one coupled EAS network device, the method may further comprise the step of: analyzing the information received from the at least one coupled EAS network device and determining if the at least one EAS network device is defined in the server. If the at least one coupled EAS network device is not defined in the server, the method may further include identifying the at least one coupled EAS network device as a new EAS network device being added to the network.

Alternatively, the method may further include identifying the at least one coupled EAS network device as an EAS network device that replaces a previously configured EAS network device. Upon querying the at least one coupled EAS network device, if the server receives as the information relating to the at least one coupled EAS network device a previously valid media access control (MAC) address or any similar identifiable address corresponding to the previously configured EAS network device, the step of configuring the EAS network device may include configuring the at least one coupled EAS network device with configuration settings of the previously configured EAS network device being replaced.

The step of listening on a specified port for connection requests from the at least one coupled EAS network device may include using transmission control protocol/internet protocol (TCP/IP) sockets for packet communication on one of a local area network (LAN) and a wide area network (WAN) between the server and the EAS network devices. In a particularly useful embodiment, before the step of listening on a specified port for connection requests from the at least one coupled EAS network device, the method may further comprise the steps of: booting at least one of the EAS network devices; and coupling or connecting the at least one booted EAS network devices to the network server if the network server IP address is configured. In addition, the method may further comprise the step of: manually entering the server IP address into the EAS network device if the network server internet protocol (IP) address is not configured. Alternatively, if the network server internet protocol (IP) address is not configured, the method may further comprise the step of: retrieving the server IP address from a dynamic host control protocol (DHCP) server that supplies the IP address to the EAS network devices.

In one particularly useful embodiment, the foregoing method steps are implemented by a program storage device readable by machine, tangibly embodying a program of instructions executable by the machine to perform method steps for automatically configuring electronic article surveillance (EAS) devices coupled to a network server.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a block diagram of one embodiment of a computer system of the present invention for automatic configuration of new, replacement or unconfigured EAS network devices;

FIG. 2 illustrates a flow diagram of one embodiment of a method of the present invention for automatically configuring new, replacement or unconfigured EAS network devices; and

FIG. 3 illustrates a flow diagram of a variation of one embodiment of the method of the present invention for automatically configuring new, replacement or unconfigured EAS network devices, the method including steps for entering a server address into the EAS network devices.

FIG. 4 illustrates a block diagram of a machine having an architecture for implementing the present invention in software as an application program tangibly embodied on a program storage device.

### DETAILED DESCRIPTION OF THE PREFERRED EMBODIMENTS

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

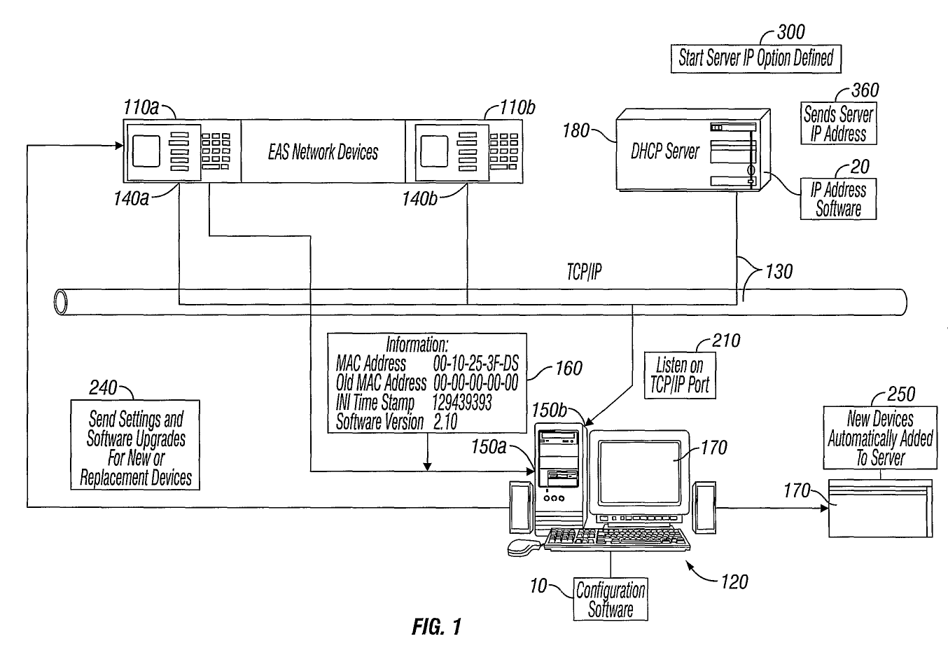

Referring now in detail to the drawings wherein like parts may be designated by like reference numerals throughout, FIG. 1 illustrates a system 100 for automatic configuration of EAS network devices. An EAS network device may be an EAS detection system, EAS deactivator, EAS alarm response panel or any device having the ability to connect to a network for the purpose of generating, collecting or reporting EAS related data. The configuration process encompasses both storing of the configuration settings needed by the EAS network device to operate as well as configuring the device on the server software that is designed to manage the EAS network devices. Configuration also includes the automatic upgrading of EAS network device software or firmware upon device detection.

The system 100 includes two parts: the server software 10 which resides on server 120; and the system architecture for implementing protocols. More particularly, the server software 10 is responsible for configuring and managing one or more EAS network devices, such as EAS network devices 110a and 110b. The term “configuration” is defined herein as including the storing of the settings configuration of the EAS network devices 110a and 110b as well as the automatic configuration of the EAS network devices 110a and 110b by the server software.

As noted above, the second part of system 100 is the system architecture which is designed to implement a protocol on at least one of the EAS network devices 110a and 110b and to allow the server 120 to query the device 110a, 110b to access information 160 about the device 110a, 110b for proper configuration purposes. The communication medium 130 for the system 100 may be, for example, a local area network (LAN) or wide area network (WAN) using typically transmission control protocol/internet protocol (TCP/IP) sockets 140a and 140b coupled to the EAS network devices 110a and 110b. The sockets 140a and 140b are coupled from server software or device manager software to the EAS devices by a virtual point-to-point connection for packet communication on one of the local area network (LAN) and a wide area network (WAN) between the server 120 and the EAS network devices 110a and 110b. The communication medium 130 is not limited to TCP/IP packet communication and other communication media may be used. The communication medium 130 may include an Ethernet interface to handle connections to external sources or over an interconnected network of computer devices, commonly referred to as the ‘internet’. The communication medium is not limited to hard-wired connections but may also include wireless modes of communication.

The software 10 resides on the server 120 and therefore resides on the same network 130 as the EAS network devices 110a, 110b. The server software 10 may have device specific and generic software modules to support the EAS network devices 110a, 110b. At least one TCP/IP socket 140a at EAS network device 110a or TCP/IP socket 140b at EAS network device 110b connects or couples at least one of the EAS network devices 110a or 110b to the network 130 for packet communication with the network 130. Using the TCP/IP sockets 140a, 140b for communication with the EAS network devices 110a, 110b, the server 120 “listens” or passively waits on a specified port 150a or 150b for connection requests from the EAS network devices 110a, 110b. When a connection from an EAS network device 110a, 110b is detected, the server 120 accepts the connection and, using a specific protocol, queries the device 110a, 110b for information 160 such as, for example, pre-configured global device settings, the device type, MAC address, and firmware or software revision levels. The MAC address is used to uniquely define units, e.g., EAS network devices such as devices 110a, 110b, in the server 120. If the device being connected is an unconfigured device, the MAC address is currently not defined in the server, so the server 120 adds the device to its list of devices to manage, with the list appearing on server screen 170. The embodiments are not limited in this context.

The EAS network device 110a, 110b is then configured by the server 120 based upon the device type. The device configuration may include downloading pre-configured global device settings and downloading the appropriate revision of firmware or software required for proper device operation.

When the server 120 detects an unconfigured EAS network device, such as EAS network devices 110a or 110b, the unconfigured EAS network device may be an entirely new device or a device replacing a prior defective device that already had been configured or a device reconnected to the network without proper configuration. Typically, the EAS network devices, such as devices 110a and 110b, are manually configurable to allow the installer to enter the MAC address of the defective device that is being replaced or the old MAC address. Upon querying the EAS network device 110a, 110b, if the server receives an old, i.e., a previously valid, MAC address corresponding to a previously configured EAS network device, the server 120 configures the replacement device with the same configuration settings as the settings of the device being replaced.

Each EAS network device 110a, 110b contains the necessary protocols to communicate the required information 160 to the server 120 so the network device such as 110a or 110b can be automatically configured. The required information 160 is the device type and the MAC address. The MAC address is used to uniquely define each EAS network device such as 110a, 110b in the server software 10. When an EAS network device such as 110a or 110b is booted, the device 110a, 110b first tries to connect to the server software 10 if the IP address of the server 120 is configured. The EAS network device 110a, 110b must have the server IP address to know where the server software 10 resides. The server IP address can be manually entered into the EAS network device or in one embodiment retrieved using a custom IP address option software package 20 residing on a dynamic host control protocol (DHCP) server 180. The DHCP server 180 is connected or coupled to the communication medium 130 and supplies the IP address of the network server 120 to the EAS network devices such as 110a and 110b.

In one particularly useful embodiment, the system 100 for automatically configuring electronic article surveillance (EAS) devices coupled to a network includes: at least one electronic article surveillance (EAS) device 110a, 110b coupled to the network 130; a server 120 coupled to the network 130. The system 100 includes software 10 tangibly embodied as one or more application programs residing on the server 120 and its associated hardware. The server 120 is adapted to: (1) await or listen on a specified server port 150a, 150b for connection requests from the EAS network devices 110a, 110b; (2) accept the connection request from at least one of the EAS network devices 110a, 110b; (3) query the coupled EAS network device 110a, 110b for information 160 relating to the at least one coupled EAS network device 110a, 110b using a specific protocol for the server 120; and (4) configure the at least one coupled EAS network device 110a, 110b based upon the information 160 received from the at least one EAS network device 110a, 110b. The server 120 may also be configured for using the MAC address to uniquely define each EAS network device 110a, 110b. When the information 160 is the coupled EAS network device type, the server 120 configures the EAS network device 110a, 110b by sending appropriate settings, configuration and software revisions to the EAS network device. The embodiments are not limited in this context.

Similarly, in another particularly useful embodiment, the server 120 may be configured to “boot” at least one of the EAS network devices 110a, 110b before initiating the listening mode on a specified port such as 150a, 150b for connection requests from the EAS network devices 110a, 110b. The server 120 then instructs the system 100 to couple the at least one booted EAS network devices 110a, 110b to the network server 120 if the network server IP address is configured. A custom option software package 20 may also be included which is configured to retrieve the server internet protocol (IP) address from the dynamic host control protocol (DHCP) server 180 that supplies the IP address to the EAS network devices 110a, 110b. The embodiments are not limited in this context.

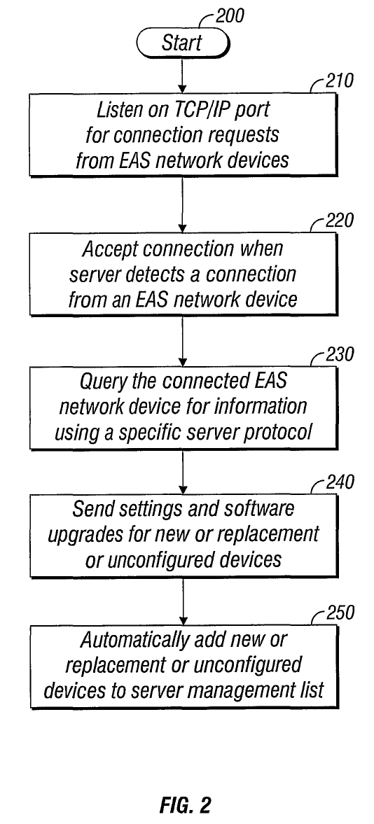

FIG. 2 illustrates a flow diagram of one embodiment of a method according to the present invention for automatically configuring new, replacement or unconfigured connected EAS network devices coupled to a network server. First, in step 200, the EAS network devices, such as devices 110a and 110b, are started up and initialized. In step 210, the server 120 performs the step of awaiting or listening on a specified pork such as 150a or 150b, for connection requests from the EAS network devices. In step 220, when the server 120 detects a connection from an EAS network device, such as 110a or 110b, the server proceeds by accepting the connection. In step 230, the server 120 queries the connected EAS network device 110a or 110b for information 160 using a specific protocol for the server. In step 240, the server 120 acts by configuring the EAS network device based upon the information received by sending configuration settings and software upgrades for any unconfigured network devices such as new, replacement or unconfigured connected devices. In step 250, when the information 160 received from the connected EAS network device such as 110a or 110b is not defined in the server 120, the server 120 adds the device to a list of devices for the server to manage.

As noted previously, the information 160 may include: (a) pre-configured global device settings; (b) a connected or coupled EAS network device type; (c) a media access control (MAC) address; (d) a firmware revision level; and/or (e) a software revision level. When the information 160 is the MAC address, the server performs the step 240 by using the MAC address to uniquely define each EAS network device 110a, 110b in the software 10 of the server 120. When the information 160 is a connected or coupled EAS network device type, the server 120 performs the step 240 of configuring the EAS network device 110a, 110b by sending appropriate settings, and configuration and/or software revisions to the EAS network device 110a, 110b. When the information 10 received from the connected EAS network device 110a, 110b is not defined in the server 120, the server 120 identifies the connected EAS network device 110a, 110b as a new EAS network device being added to the network. Alternatively, when the information 10 received from the coupled EAS network device 110a, 110b is not defined in the server 120, the server 120 may identify the coupled EAS network device 110a, 110b as an EAS network device 110a, 110b that replaces a previously configured EAS network device. The embodiments are not limited in this context.

Upon querying the connected EAS network device in step 230, if the server receives as the information an old, i.e., previously valid, media access control (MAC) address, the step 240 of configuring the EAS network device additionally or alternatively includes configuring the EAS network device with the configuration settings of the previously configured device that is being replaced.

The step 210 of awaiting or listening on a specified port 150a, 150b for connection requests from the EAS network devices 110a, 110b additionally or alternatively includes using transmission control protocol/internet protocol (TCP/IP) sockets 140a, 140b for packet communication on one of the local area network (LAN) and the wide area network (WAN) between the server 120 and the EAS network devices 110a, 110b. The embodiments are not limited in this context.

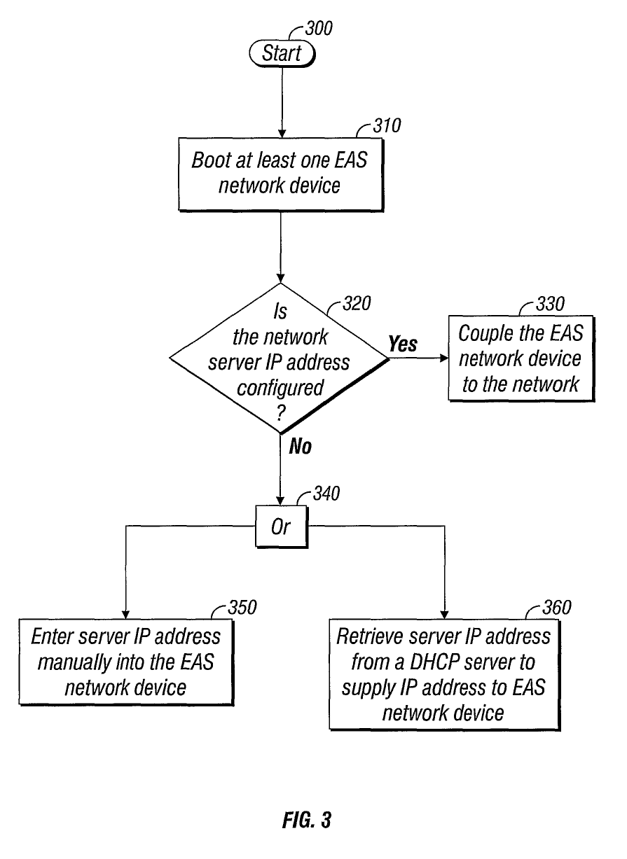

FIG. 3 illustrates a flow diagram of one particularly useful variation of the method of the present invention for automatically configuring new or replacement EAS network devices. First, prior to performing the step 210 of awaiting or listening on a specified port such as 140a, 140b for connection requests from the EAS network devices 110a, 110b, the method includes the step 310 of booting the EAS network devices. In step 320, it is determined whether the network server IP address is configured. If yes, in step 330, the at least one booted EAS network device is connected or coupled to the network server 120. If no, through OR gate 340, either step 350 or step 360 may be implemented. In step 350, a user may manually enter the server IP address into the EAS network device 110a, 110b. Typically, an electromechanical interface such as, for example, a scanner, a key board, a data card, an optical reader, a cursor control device, e.g., a mouse or a terminal is configured to interface with the EAS network device 110a, 110b to allow the manual entry of the server IP address. In step 360, the at least one booted EAS network device 110a, 110b may retrieve the server IP address from the dynamic host control protocol (DHCP) server 180 that supplies the IP address to the EAS network devices such as 110a, 110b. The embodiments are not limited in this context.

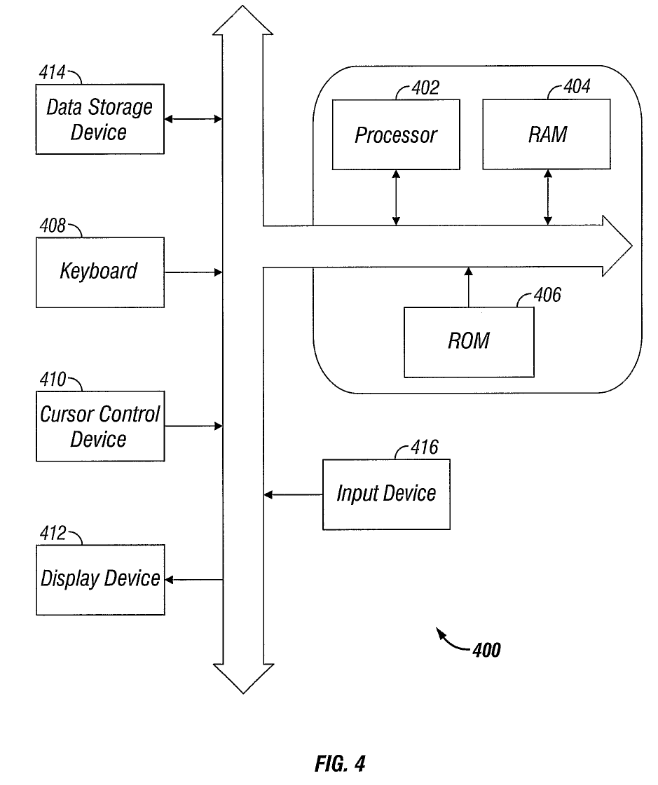

It is to be understood that the present invention may be implemented in various forms of hardware, software, firmware, special purpose processors, or a combination thereof. In one embodiment, the present invention may be implemented in software as an application program tangibly embodied on a program storage device. The application program, such as server software 10, 20 or any algorithm, flow diagram or block diagram disclosed herein, may be uploaded to, and executed by, a machine comprising any suitable architecture such as that shown in FIG. 4. Preferably, the machine 400 is implemented on a computer platform having hardware such as one or more central processing units (CPU) 402, a random access memory (RAM) 404, a read only memory (ROM) 406 and input/output (I/O) interface(s) such as keyboard 408, cursor control device (e.g., a mouse) 410 and display device 412. The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device 414 and a printing device. Furthermore, an input device or mechanical interface, e.g., a scanner device 416, may be coupled to the machine 400 for collecting image data.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Therefore and as can be appreciated, the invention provides a significant reduction in labor expenses for installation and maintenance of an EAS network device. Moreover, the EAS network device can be installed (i.e., in this instance simply plugged in) by an untrained contractor. Since the configuration of the EAS network device is done automatically, the need for a trained service technician to install, replace or upgrade an EAS network device is negated in most instances.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A system for automatically configuring electronic article surveillance (EAS) devices coupled to a network, comprising:
a server coupled to the network, the server adapted to
(1) listen on a specified port for connection requests from at least one coupled EAS network device;
(2) accept the connection request from at least one coupled EAS network device;
(3) query at least one coupled EAS network device for information relating to at least one EAS network device; and
(4) configure at least one coupled EAS network device based upon the information received from at least one EAS network device.

2. The system according to claim 1, wherein the server includes software which
(1) listens on a specified port for connection requests from at least one coupled EAS network device;
(2) accepts the connection request from the at least one coupled EAS network device;
(3) queries the at least one coupled EAS network device for information relating to the at least one EAS network device; and
(4) configures the at least one coupled EAS network device based upon the information received from the at least one EAS network device.

3. The system according to claim 1, wherein the server includes hardware which
(1) listens on a specified port for connection requests from at least one coupled EAS network device;
(2) accepts the connection request from the at least one coupled EAS network device;
(3) queries the at least one coupled EAS network device for information relating to the at least one EAS network device; and
(4) configures the at least one coupled EAS network device based upon the information received from the at least one EAS network device.

4. The system according to claim 1, wherein:
the information relating to the at least one coupled EAS network device is selected from the group consisting of (a) pre-configured global device settings, (b) the at least one coupled EAS network device type, (c) media access control (MAC) address, (d) firmware revision level, and (e) software revision level.

5. The system according to claim 4, wherein the information relating to the at least one coupled EAS network device is the MAC address, and the server is configured to use the MAC address to uniquely define each EAS network device in software of the server.

6. The system according to claim 4, wherein the information relating to the at least one coupled EAS network device is the at least one coupled EAS network device type, and the server configures the at least one coupled EAS network device by sending configuration settings and software revisions to the at least one coupled EAS network device appropriate for the type of the at least one coupled EAS network device.

7. The system according to claim 1, wherein the server adds the at least one coupled EAS device to a list of devices for the server to manage when the information received from the at least one coupled EAS network device is not defined in the server.

8. The system according to claim 1, wherein the server identifies the at least one coupled EAS network device as a new EAS network device being added to the network when the information received from the at least one coupled EAS network device is not defined in the server.

9. The system according to claim 1, wherein the server identifies the at least one coupled EAS network device as an EAS network device that replaces a previously configured EAS network device when the information received from the at least one coupled EAS network device is not defined in the server.

10. The system according to claim 9, wherein upon querying the connected EAS network device, the server configures the at least one coupled EAS network device with configuration settings of the previously configured EAS network device if the server receives as the information a previously valid media access control (MAC) address corresponding to the previously configured EAS network device.

11. The system according to claim 1, further comprising:
at least one transmission control protocol/internet protocol (TCP/IP) socket coupling the at least one coupled EAS network device to the network for packet communication with the network.

12. The system according to claim 11, wherein the server listens through the at least one TCP/IP socket on a specified port for connection requests from the at least one coupled EAS network device.

13. The system according to claim 1, wherein the network is one of a local area network (LAN) and a wide area network (WAN).

14. The system according to claim 11, wherein the network is one of a local area network (LAN) and a wide area network (WAN).

15. The system according to claim 1, wherein the server is configured to boot at least one of the at least one coupled EAS network devices before listening on a specified port for connection requests from the at least one coupled EAS network devices

16. The system according to claim 15, wherein the server is configured to connect the at least one booted EAS network devices to the network server if the network server IP address is configured.

17. The system according to claim 15, further comprising at least one electromechanical interface interfacing with the at least one booted EAS network device and configured to allow a user to manual enter the server internet protocol (IP) address into the at least one booted EAS network device.

18. The system according to claim 17, wherein the at least one electromechanical interface is selected from the group consisting of (a) a key board; (b) a data card; (c) an optical reader; (d) a cursor control device and (e) a terminal.

19. The system according to claim 15, further comprising at least one electromechanical interface interfacing with the at least one booted EAS network device and configured to retrieve the server internet protocol (IP) address from a dynamic host control protocol (DHCP) server that supplies the IP address to the EAS network devices.

20. The system according to claim 2, wherein the software has device specific and generic software modules to support the EAS network devices.
